(19) United States
(12) Patent Application Publication
(10) Pub. No.: US 2022/0322747 A1
(43) Pub. Date: Oct. 13, 2022

(54) Mass Flow Meter for an Electronic Cigarette

(71) Applicant: JT International S.A., Geneva (CH)

(72) Inventors: Claude Zominy, Copponex (FR); Roland Wuttke, Nyon (CH)

(73) Assignee: JT International S.A., Geneva (CH)

(21) Appl. No.: 17/621,039

(22) PCT Filed: Jun. 15, 2020
(86) PCT No.: PCT/EP2020/066500

§ 371 Date: Dec. 20, 2021

(30) Foreign Application Priority Data
Jun. 21, 2019 (EP) 19181843.4

(51) Int. Cl. A24F 40/51; A24F 40/42; A24F 40/10; A24F 40/44; A24F 40/46; A24F 40/57; A24F 40/53; G01F 1/69

(52) U.S. Cl. CPC A24F 40/51; A24F 40/42; A24F 40/10; A24F 40/44; A24F 40/46; A24F 40/57; A24F 40/53; G01F 1/69

(57) ABSTRACT

An electronic cigarette includes a liquid store, a vaporizer, a fluid transfer element, a sensing unit and control circuitry. The sensing unit is configured to measure flow of vaporizable liquid in the fluid transfer element and the control circuitry is configured to control at least one aspect of the electronic cigarette based on the measured flow rate.

### CROSS-REFERENCE TO RELATED APPLICATIONS

The present application is a national phase entry under 35 U.S.C. § 371 of International Application No. PCT/EP2020/066500, filed Jun. 15, 2020, published in English, which claims priority to European Application No. 19181843.4 filed Jun. 21, 2019, the disclosures of which are incorporated herein by reference.

### BACKGROUND OF THE INVENTION

The present invention relates to an electronic cigarette in which a fluid transfer element can transport liquid from a liquid store to a vaporizer.

Electronic cigarettes that vaporise a vaporizable liquid are becoming popular as consumer devices. It is important in these devices to carefully control the vaporiser so that a predictable and repeatable vapour is generated for a user to inhale. It has been found that it can be difficult to provide this kind of repeatability and predictability in all circumstances, and particularly when the liquid store is close to empty.

A known phenomenon amongst electronic cigarette users is an event known as a ‘dry puff’. Under ‘dry puff’ conditions, there is insufficient liquid transport to the vaporizer for the applied electrical power and inhalation of the produced vapour can lead to an unpleasant taste being detected by the user. Therefore, the ability to reduce the likelihood of ‘dry puff’ conditions would be of benefit to electronic cigarette users.

### BRIEF SUMMARY OF THE INVENTION

An object of the present invention is to address some of these issues.

According to an aspect of the invention there is provided an electronic cigarette comprising: a liquid store; a vaporizer; a fluid transfer element configured to conduct liquid from the liquid store to the vaporizer; a sensing unit configured to measure the flow of liquid in the fluid transfer element; and control circuitry configured to control at least one aspect of the electronic cigarette based on the measured flow rate.

In this way, it is possible to control the electronic cigarette based on the measured flow rate so that it can continue to be used effectively even when the flow rate varies. In one example, a low flow rate may be indicative of a liquid store which has become depleted and the electronic cigarette may be disabled to prevent inadvertent damage to the vaporizer and/or to prevent the user from experiencing ‘dry puff’ phenomenon. In another example, power supply to the vaporizer may be adjusted depending on the flow rate so that the vaporization is repeatable, predictable, and independent of the flow rate in the fluid transfer element.

The vaporizer may comprise a first heater. In this way, heat can be transferred to the liquid within the fluid transfer element such that the liquid temperature is elevated to its vaporization point and a vapour is produced. The vapour may be collected, extracted, or inhaled directly by a user. In alternative arrangements the vaporizer could comprise an atomizer. The heater is preferably a heating element, which may be wound around the fluid transfer element. In an alternative arrangement the heater may comprise a laser or other optical heating source.

Preferably, the sensing unit comprises a second heater and a temperature sensor separated from one another in the fluid transfer element between the vaporizer and the liquid store. In this way, the sensing unit can measure mass flow within the fluid transfer element by heating the liquid within the fluid transfer element using the second heater and measuring the effect of this heating operation at the temperature sensor. Thus, if the flow rate is low, the time taken for a change in temperature at the second heater to be detected at the temperature sensor may be relatively long (in comparison to a high flow rate). Moreover, the effect of the heating operation can also be continuously measured over time. This can provide an indication of changes in the liquid flow rate in the fluid transfer element and enable the control circuitry to execute a corrective action if needed.

In one arrangement, the second heater may be wound around the fluid transfer element. In another arrangement, the second heater may be provided inside the fluid transfer element.

Preferably, the sensing unit comprises a resistive sensor configured to measure the resistance of a heater element in the second heater in order to measure the temperature of the heater element. It has been found that measuring electrical resistance can be an effective way to determine temperature. This ensures that the temperature of the second heater can be tightly controlled, which is important for ensuring the accuracy of the sensing unit. In another example, the temperature of the heater element in the second heater may be determined using a thermocouple or other temperature sensor.

Preferably, the sensing unit comprises a timer for monitoring the time at which changes in temperature are applied by the second heater and the time at which temperature measurements are made by the temperature sensor. In this way, the time taken for changes in temperature to propagate from the second heater to the temperature sensor can be measured. It is believed that the time taken for changes to be measured is dependent on the distance between the second heater and the temperature sensor, the thermal conductivity and diffusivity of the liquid, and the average flow rate. Hence, by using suitable look-up tables (e.g. containing data relating to the transportation time and temperature profile of the liquid) the mass flow rate of liquid in the fluid transfer element can be calculated.

The control circuitry may be configured to reduce or suspend operation of the vaporizer if the flow rate measured by the sensor is below a predetermined threshold. ‘Dry puff’ conditions or liquid depletion are known to correspond to a low mass flow rate. Thus, reducing or suspending operation of the vaporizer when the mass flow rate is low avoids vaporization during these conditions, providing an improved user experience and preventing damage to the vaporizer. In addition, the production of undesired volatile compounds is inhibited and an indication is provided to the user that the liquid store is empty or near to empty. Preferably, the control circuitry is configured to modify the power supplied to the vaporizer dependent on the flow rate measured by the sensing unit. In this way, enhanced control of vapour emissions is provided. It is believed that there is a relationship between the maximum electrical power that can be delivered to the vaporizer, the temperature of the vaporizer, and the mass of the liquid that is vaporized. The amount of vaporized liquid is proportional to the electrical energy provided to the vaporizer until an upper limit is reached where the amount of vaporized liquid becomes independent of electrical power due to the fluid transfer element reaching its capillary limit. By monitoring the amount of liquid in the fluid transfer element flowing to the vaporizer, the electrical power can be adjusted accordingly to provide the optimal electrical power for the operating conditions and ensure a predictable and repeatable vapour is generated for a user to inhale. As another example, reduction of the electrical power during low mass flow conditions may prevent the formation of undesirable compounds such as carbonyls. This may be achieved by preventing the temperature of the vaporizer exceeding the temperature of decomposition of the liquid constituents. As another example, adjusting the electrical power supplied to the vaporizer can improve electrical efficiency. In one example, a look up table may be used to adjust the electrical power supplied to the first heater based on the mass flow rate calculation.

The fluid transfer element may comprise a porous material. In this way, wicking is promoted along the fluid transfer element as a result of capillary suction within the porous medium. Thus, liquid flow can occur without the assistance of, or even in opposition to, external forces like gravity. The fluid transfer element can be characterised by its capillary properties, which are based on factors such as material type (e.g. fibre glass, cotton, ceramic etc.) and physical dimensions (e.g. diameter, number of ropes, material density etc.).

According to another aspect of the invention, there is provided a method of operating an electronic cigarette, comprising the steps of: conducting liquid from the liquid store to the vaporizer using the fluid transfer element; measuring the flow of liquid in the fluid transfer element with the sensing unit; and controlling at least one aspect of the electronic cigarette based on the measured flow rate.

### BRIEF DESCRIPTION OF THE DRAWINGS

Embodiments of the invention are now described, by way of example, with reference to the drawings, in which:

FIG. 1 is a schematic view of an electronic cigarette in an embodiment of the invention;

FIG. 2 is a schematic overview of the internal components of an electronic cigarette in an embodiment of the invention;

FIG. 3 is a schematic cross-sectional view of the internal components of an electronic cigarette in an embodiment of the invention;

FIG. 4 is a block diagram of system components of an electronic cigarette in an embodiment of the invention;

FIG. 5 is a flowchart showing method steps for operation of an electronic cigarette in accordance with an embodiment of the invention; and

FIG. 6 is two schematic graphs illustrating temperature versus time in a mass flow measurement sensor.

### DETAILED DESCRIPTION

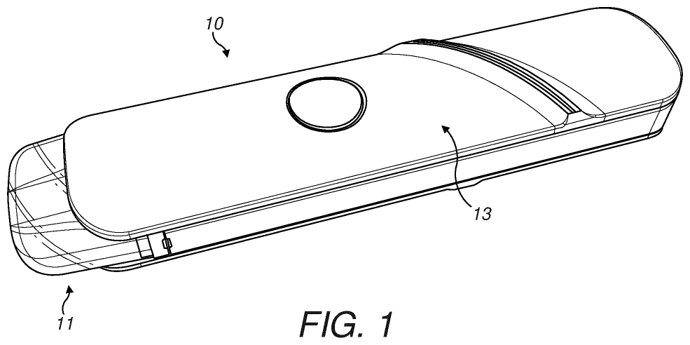

FIG. 1 is a schematic view of an electronic cigarette 10 in an embodiment of the invention. The electronic cigarette 10 can be used as a substitute for a conventional cigarette comprising shredded tobacco. The electronic cigarette 10 comprises a capsule 11 and an elongate main body 13. The capsule 11 may either be removable or permanently secured.

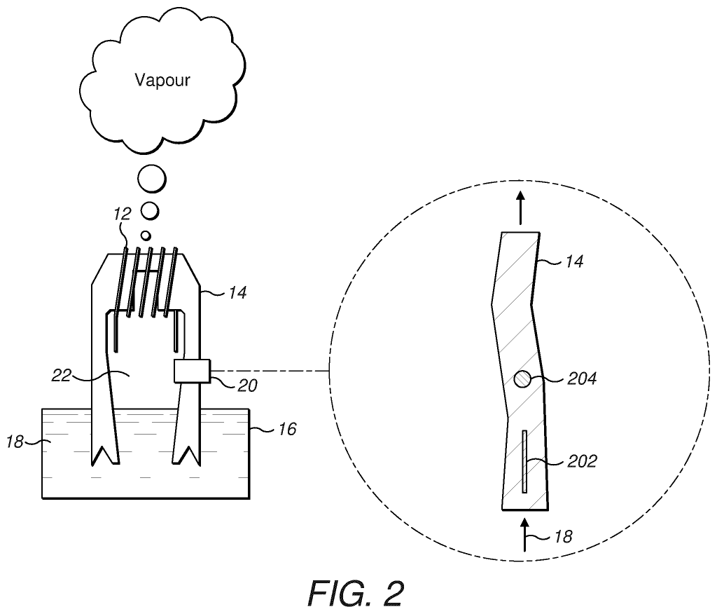

FIG. 2 is a schematic overview of the internal components of an electronic cigarette 10, which may be housed in a capsule/cartridge. The electronic cigarette 10 comprises a first heating element 12, a wick 14 and a liquid reservoir 16 containing vaporizable liquid 18. The wick 14 is a fluid transport element that extends from the liquid reservoir 16 to the first heating element 12, facilitating the transport of liquid 18 by capillary action to the first heating element 12 for vaporization. The liquid reservoir 16 can be configured as a refillable “open tank” reservoir or a removable cartridge or consumable. The vaporizable liquid 18 may be propylene glycol or glycerin, which is able to produce a visible vapour. The vaporizable liquid 18 may further comprise other substances such as nicotine and flavorings.

A flow sensor 20 is located at a position along the wick 14, between the liquid reservoir 16 and the first heating element 12. The flow sensor 20 comprises a second heating element 202 and a temperature sensor 204 situated within the wick 14. In alternative embodiments, the second heating element 202 and the temperature sensor 204 may be positioned around the wick 14 or a combination of both within and around the wick 14. An air flow conduit 22 is located within the electronic cigarette 10.

Alternatively, a plurality of mass flow sensors can be used. For instance, a first and a second mass flow sensor can be arranged at each end of elongated wick 14. A plurality or at least two mass flow sensors can provide additional data such that an average mass flow from can be calculated.

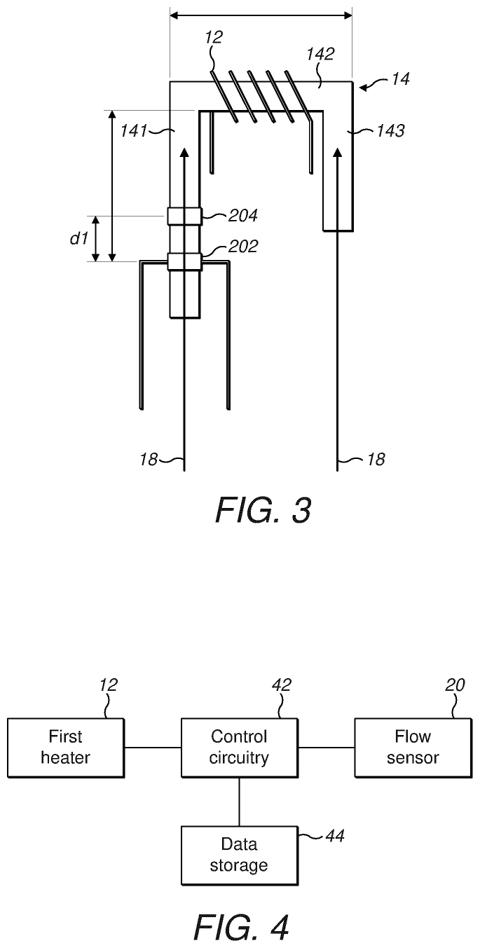

FIG. 3 shows a schematic cross-sectional view of the internal components of an electronic cigarette in an embodiment of the invention. The electronic cigarette comprises a first heating element 12, a wick 14, a second heating element 202 and a temperature sensor 204.

The first heating element 12 may be a metallic coil made of a material such as titanium, nickel or Nichrome. Typical electrical resistance values for the coil range from approximately 1.5 to 2.0 Ω but may be lower (such as in the case of titanium). As will be appreciated by a person skilled in the art, a number of other heat-conducting materials may be used for the first heating element 12. In alternative embodiments, the first heating element 12 may be any other system capable of vaporizing a liquid transported along the wick 14, such as a laser or other optical heating source.

The wick 14 is operable to conduct liquid 18 from the liquid reservoir 16 to the first heating element 12. Typically, the movement of liquid 18 is achieved by capillary action. The capillary properties of the wick 14 depend on various factors such as the wick 14 material (e.g. fibre glass, cotton, ceramic etc.) and physical dimensions (e.g. diameter, number of ropes, material density etc.). A typical wick diameter may be approximately 3 mm. These factors also play a role in determining the capillary limit of the wick 14, i.e. where the wick reaches a maximum liquid mass flow rate, thereby also influencing the maximum liquid vaporization rate. In addition, mass transportation along the wick 14 is dependent on the liquid properties (e.g. viscosity) and the operating conditions (e.g. temperature).

In one example, the wick 14 comprises at least two spatially separated parallel lengths of wicking material 141 and 143, connected at one end by a connecting portion 142. The first heating element 12 is located at the connecting portion 142 such that liquid 18 travelling along each parallel section of the wick 14 converges and is vaporized at the first heating element 12. Typically, the connecting portion 142 may be approximately 5 mm in length. In alternative examples, the wick 14 may consist of one length of wicking material or may comprise a hollow cylinder such that liquid flow can be maximised parallel to the cylindrical axis whilst maintaining sufficient space for the passage of air or vapour.

The second heating element 202 may be provided around the wick 14 (such as a heating coil or heating ring), inside the wick 14, or a combination. The second heating element 202 is located such that liquid 18 flowing along the wick 14 passes the second heating element 202, then the temperature sensor 202, before arriving at the first heating element 204. The second heating element 202 is operable to elevate the temperature of the liquid transported along the wick to a temperature below the vaporization point of the liquid 18. A typical vaporization temperature may be approximately 200 to 290° C., while the temperature in the location of the second heating element 202 is lower. In an example, the temperature at the second heating element 202 can be for example around 80° C. The temperature of the second heating element 202 can be accurately detected and controlled by measuring the resistance of the second heating element 202. In alternative examples, the temperature of the second heating element 202 may be monitored using a thermocouple or other temperature sensor.

The temperature sensor 204 is used to measure the temperature of the vaporizable liquid 18 within the wick 14. The liquid temperature is elevated by the second heating element 202 before flowing to the temperature sensor 204 then onto the first heating element 12 to be vaporised. The distance (d1) between the second heating element 202 and the temperature sensor 204 is adjusted by design depending on the mass flow transfer capability of the system. The temperature sensor 204 typically comprises a coil, made of a material such as titanium, which may be wrapped around the wick 14, or located internally, or a combination. By measuring the resistance of the coil the temperature can be determined. In other examples, the temperature sensor 204 may comprise a thermocouple or other system capable of measuring temperature.

FIG. 4 is a block diagram of system components of an electronic cigarette in an embodiment of the invention. Control circuitry 42 is provided in electronic communication (e.g. wired or wireless) with a first heater 12, a flow sensor 20 and a data storage unit 44. The control circuitry 42 may comprise at least one processor and a memory (not shown). The memory may store a computer program embodied in a non-transitory computer readable storage medium having computer-executable instructions for performing the various functions of the control circuitry 42. As will be appreciated by a person skilled in the art, the data storage unit 44 may be located within the electronic cigarette 10 or may be located remotely, such as in the case of a remote server.

The control circuitry 42 may be responsible for controlling the operation of the electronic cigarette 10, such as monitoring the temperature evolution of the system, recording or retrieving data in data storage 44, and controlling the power supplied to the first heater 12 and flow sensor 20. The data storage unit 44 may contain data such as look-up tables, historical mass flow data and calibration data.

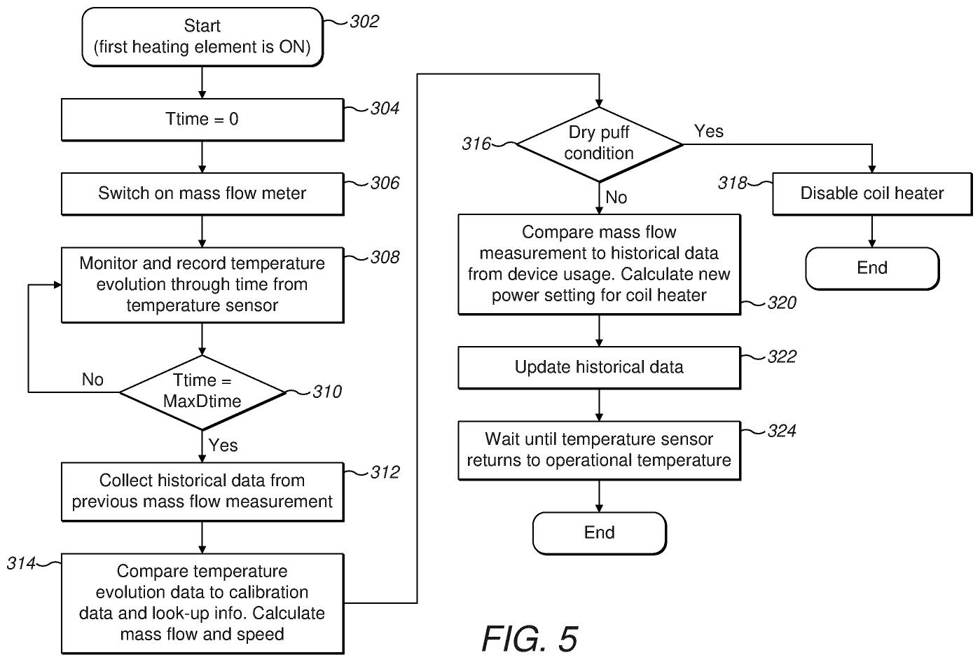

FIG. 5 illustrates a method of operation for an electronic cigarette in accordance with an embodiment of the invention.

The mass flow measurement is initiated during the vaporization process. As such, operation commences at step 302 with the switch-on of the first heating element 12. At step 302, liquid 18 flows from the liquid reservoir 16 to the first heating element 12 and is vaporised. A timer is operable to record the transportation time (Ttime) of liquid flowing from the second heating element 202 to the temperature sensor 204. This allows for monitoring of temperature evolution with respect to time. At step 304 the timer is reset (Ttime=0).

The second heating element 202 is activated at step 306. The power supplied to the second heating element 202 will depend on the desired temperature set point, which is configurable according to system requirements. The temperature set point is chosen such that the temperature of the liquid 18 is elevated to a temperature below the vaporization temperature of the liquid 18. Advantageously, the resistance of the second heating element 202 may be monitored to provide an accurate measurement of the temperature of the second heating element 202.

In one embodiment, the second heating element 202 may be switched on and off rapidly such that a thermal pulse is transmitted along the wick 14 in the liquid 18. In another embodiment, the second heating element 202 may remain switched on until a specific time or temperature threshold is reached.

At step 308 the temperature evolution of the wick 14 and the liquid 18 within the wick 14 is recorded by the temperature sensor 204. In this way, the temperature evolution is monitored during the time taken for the liquid 18 to travel from the second heating element 202 to the temperature sensor 204. At step 310 recording of the temperature evolution is stopped. This occurs either due to a maximum temperature threshold being reached or due to a maximum period of time having elapsed (Time=MaxDtime). The maximum temperature threshold may correspond to a temperature just below the vaporization temperature of the liquid 18. If neither of the conditions are reached, the heating and monitoring process is continued by looping back to step 308.

Historical data from previous mass flow measurements are retrieved at step 312 from data storage 44. These data enable evaluation of the liquid depletion and degradation of the system by comparing the historical data with measured data. Contamination of the wick may lead to capillary degradation, arising due to the incorporation of foreign or extraneous matter or the adherence of liquid residue to the wick. Alternatively, degradation may occur due to liquid depletion.

At step 314 the mass flow rate is calculated using the time (Ttime) recorded for heated liquid to flow from the second heating element 202 to the temperature sensor 204 and the temperature profile recorded during the elapsed time, and comparing these data to calibration data and/or a look-up table (LT1). The look-up table (LT1) contains data relating the mass flow rate to the measured transportation time (Ttime) and the temperature profile of the temperature sensor 204.

At step 316 ‘dry puff’ conditions are evaluated. The control circuitry 42 estimates whether ‘dry puff’ conditions are about to be met or are already met using the calculated mass flow rate. ‘Dry puff’ conditions or liquid depletion in the liquid reservoir 16 correspond to a low mass flow rate, thus impacting the recorded transportation time (Ttime), recorded temperature profile and the calculated mass flow rate. If ‘dry puff’ conditions are estimated as having been met or about to be met, or liquid depletion is detected, the first heating element 12 is switched off. In one example, an alarm may be triggered or the user notified in an appropriate manner. In this way, the user is prevented from experiencing the ‘dry puff’ phenomenon and the notifying alert or communication ensures the user understands that the electronic cigarette 10 is no longer operational. Moreover, it may provide an indication that the liquid reservoir 16 needs refilling or replacing.

If ‘dry puff’ conditions or liquid depletion are not detected, the power supplied to the first heating element 12 may be adjusted in accordance with the mass flow data. The historical mass flow data and a second look-up table (LT2) defining the relationship between the mass flow rate and the electrical power supplied to the first heating element 12 for the specific wick properties (e.g. capillarity properties, dimensions etc.) can be used to determine an appropriate adjustment of the supplied power to achieve a desired mass flow rate and level of liquid vaporization. In this way, the optimal amount of electrical power can be provided for the operating conditions so that degradation of the liquid 18 can be avoided during the vaporization process and a predictable and repeatable vapour is generated for the user to inhale. As another example, reduction of the electrical power during low mass flow conditions may prevent the formation of undesirable compounds such as carbonyls by avoiding exceedance of the temperature of decomposition of the liquid constituents. As another example, adjusting the electrical power supplied to the vaporizer in accordance with the mass flow rate may improve electrical efficiency.

A correction factor may be applied to the calculated power output which accounts for wick degradation or liquid depletion in the system. This can be calculated by comparing the measured mass flow data with the historical mass flow data. In addition, the historical data may be used to account for fluctuations in the system by calculating an average mass flow rate, thereby improving the accuracy of the power adjustment.

At step 322 the mass flow measurement data and adjusted settings are recorded in data storage 44 for the next measurement phase.

At step 324 the temperature sensor 204 continues to monitor the temperature of the wick 14 until a steady-state temperature is detected. When a steady-state temperature occurs, the mass flow measurement may be restarted at step 304.

It will be understood by the skilled person that the mass flow measurement described above is a two phase process: a first phase to the heat the vaporizable liquid 18 and a second phase to allow the vaporizable liquid 18 to cool. In the first phase, the vaporizable liquid 18 is heated sufficiently to allow for easy and fast temperature detection and to provide sufficient temperature evolution data for mass flow calculations to be performed based on the time taken for heated liquid to reach the temperature sensor 204. In the second/cool-down phase, the second heating element 202 is switched off for at least the time taken for the temperature sensor 204 to detect a steady-state temperature.

In one example, the cool-down phase may be initiated at step 308, corresponding to the case where the second heating element 202 is pulsed on and off. In another example, the cool-down phase may be initiated at step 310 if the second heating element is switched off due to a time or temperature threshold being reached. In a further example, the cool-down phase may be initiated at step 324 if the second heating element 202 remains activated until this point.

The mass flow measurement may be performed continuously during the vaporization process so that the first phase begins again immediately when a steady-state temperature is detected by the temperature sensor 204. In one example, steps 302 to 324 may be repeated several times sequentially, such as 3 to 5 times in 30 to 60 seconds. In this way, an average mass flow measurement can be calculated providing greater accuracy.

Alternatively, the mass flow measurement may be performed at any point during the vaporization process such that the first phase is not resumed immediately following detection of a steady-state temperature. In one example, steps 302 to 324 may be repeated at regular intervals such as every 60 seconds or every 5 puffs.

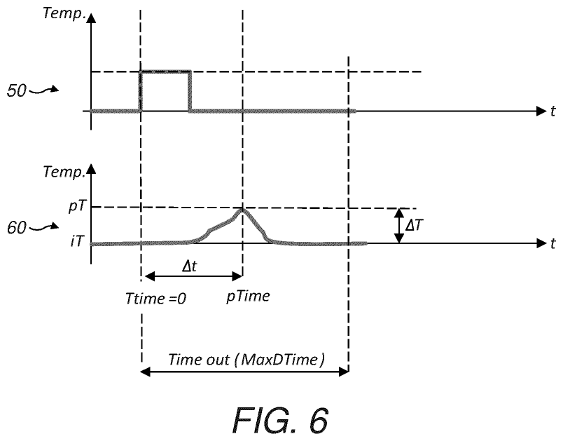

FIG. 6 shows two schematic graphs illustrating a typical sequence of events and data collected in a mass flow measurement. Graph 50 is a plot of temperature at the second heating element 202 versus time recorded in data storage 44 by the control circuitry 42. Graph 60 is a plot of temperature at the temperature sensor 204 versus time recorded in data storage 44 by the control circuitry.

At Ttime=0, the control circuitry 42 switches on the second heating element 202 to transmit a thermal pulse along the wick 14 in the liquid 18. The initial wick 14 temperature (iT) at the temperature sensor 204 is monitored by the control circuitry 42 and recorded in data storage 44. The temperature evolution continues to be monitored during the time taken for the liquid 18 to travel from the second heating element 202 to the temperature sensor 204 until a specific time has elapsed (Ttime=MaxDtime). The temperature profile is analysed by the control circuitry 42 to determine the peak value of temperature (pT) and the time at which this occurs (pTime). This allows for calculation of the temperature increase (ΔT=pT−iT) and the flying time (Δt=pTime). These data are then used to calculate the mass flow rate using a look-up table (LT1) stored in data storage 44 containing wick specific data relating mass flow rate to ΔT and Δt. If the control circuity 42 cannot determine a peak in temperature before the specific time has elapsed (Ttime=MaxDtime), this may be indicative of a low mass flow rate.

In an alternative embodiment, the temperature at the temperature sensor 204 may continue to be monitored by the control circuity 42 until a maximum temperature threshold is reached, such as corresponding to a temperature just below the vaporisation temperature of the liquid 18.

1. An electronic cigarette comprising:
a liquid store;
a vaporizer;
a fluid transfer element configured to conduct liquid from the liquid store to the vaporizer;
a sensing unit configured to measure a flow rate of liquid in the fluid transfer element; and
control circuitry configured to control at least one aspect of the electronic cigarette based on the measured flow rate.

2. The electronic cigarette of claim 1, wherein the vaporizer includes a first heater.

3. The electronic cigarette of claim 2, wherein the sensing unit includes a second heater and a temperature sensor separated from one another along the fluid transfer element between the vaporizer and the liquid store.

4. The electronic cigarette of claim 3, wherein the second heater is wound around the fluid transfer element.

5. The electronic cigarette of claim 3, wherein the second heater is provided inside the fluid transfer element.

6. The electronic cigarette of claim 3, wherein the sensing unit includes a resistive sensor configured to measure the resistance of a heater element in the second heater in order to measure temperature of the heater element.

7. The electronic cigarette of claim 3, wherein the sensing unit includes a thermocouple configured to measure the temperature of the heater element.

8. The electronic cigarette of claim 3, wherein the sensing unit further comprises a timer for monitoring a time at which changes in temperature are applied by the second heater and a time at which temperature measurements are made by the temperature sensor.

9. The electronic cigarette of claim 1, wherein the control circuitry is configured to reduce or suspend operation of the vaporizer when the flow rate measured by the sensing unit is below a predetermined threshold.

10. The electronic cigarette of claim 1, wherein the control circuitry is configured to modify operation of the vaporizer dependent on the flow rate measured by the sensing unit.

11. The electronic cigarette of claim 1, wherein the fluid transfer element comprises a porous material.

12. A method of operating the electronic cigarette of claim 1, comprising the steps of:
conducting liquid from the liquid store to the vaporizer using the fluid transfer element;
measuring the flow rate of liquid in the fluid transfer element with the sensing unit; and
controlling at least one aspect of the electronic cigarette based on the measured flow rate.
